(19) United States
(12) Patent Application Publication
(10) Pub. No.: US 2018/0331839 A1
(43) Pub. Date: Nov. 15, 2018

(54) EMOTIONALLY INTELLIGENT CHAT ENGINE

(71) Applicant: Microsoft Technology Licensing, LLC, Redmond, WA (US)

(72) Inventors: Bin GAO, Beijing (CN); Di HE, Beijing (CN); Tie-Yan LIU, Beijing (CN)

(73) Assignee: Microsoft Technology Licensing, LLC, Redmond, WA (US)

(21) Appl. No.: 15/776,786

(22) PCT Filed: Dec. 15, 2016
(86) PCT No.: PCT/US2016/066739

§ 371 Date: May 16, 2018

(30) Foreign Application Priority Data
Dec. 22, 2015 (CN) 201510974694.3

(51) Int. Cl. H04L 12/18; H04L 12/58; G06K 9/00; G06F 9/451

(52) U.S. Cl. CPC H04L 12/1822; G06F 9/453; G06K 9/00302; H04L 51/02

(57) ABSTRACT

A chat engine is disclosed herein that can conduct emotionally intelligent chat conversations with client device users. User chat responses and surrounding environmental data are analyzed to respectively detect the user's emotional state and surrounding environments. A series of response selector components identify or generate possible chat responses to a user's chat statements based on the detected emotional states environment of the user. Emotionally intelligent chat responses are selected for presentation to a user based on calculated likelihoods that the responses will likely change or maintain the user's emotional state. Using the techniques disclosed herein, the chat engine tailors conversational responses to a user depending the user's detected emotional state.

### BACKGROUND

Software applications on today's computing devices have exploded in popularity, managing everything from work productivity, weight loss, Web searching, and other aspects of the modern user's life. As devices shrink in size to become more mobile, less space is available to engage a user in an appealing manner, and conventional user interfaces (e.g., keyboards and mice) are rather cumbersome to users on the go. Some conventional mobile devices (e.g., smart phones and tablets) are equipped with software-based virtual assistants that use speech recognition as a way to input device instructions. For example, these virtual assistants allow users to dictate text messages, ask where the closest barbeque restaurant is located, search the Web, play unheard voice mails, and carry out a bevy of other tasks for the user.

Conventional virtual assistants generally work by recognizing and interpreting a user's voice, identifying tasks in user commands, and then responding to the tasks. But human conversation is far more complex than just recognizing words and responding. Numerous other considerations influence the best way to communicate with people, such as age, culture, emotional state, and demographics. For example, conversations with a child may need to be conducted differently than conversations with an adult. The user's environment, culture, society, and other activities may also influence the best way to communicate with users. Thus, there are many different influences to interacting with human users. Conventional digital assistants merely search for relevant information to user's text or speech without taking into account the emotional state of the user or various other factors other than speech or text.

### SUMMARY

The disclosed examples are described in detail below with reference to the accompanying drawing figures listed below. The following summary is provided to illustrate some examples disclosed herein, and is not meant to necessarily limit all examples to any particular configuration or sequence of operations.

Some examples are directed to operating a chat engine configured to hold emotionally intelligent chat conversations with a user. In some examples, a chat engine presented to a user captures user input data in the form of text, video, audio, or images. Additionally, the chat engine may also capture environmental data using a collection of device sensors or background information in user input data (e.g., background of an image or sound recording). The emotional states of users are determined from the user input data and environmental data. Response selector components are executed, either in sequence or in parallel to determine one or more responses for the user chat statements in the user input data. Emotionally tailored chat responses may then be chosen based on the emotional states of the users and calculated likelihoods that the potential chat responses may either change or maintain the users' emotional states. The emotionally tailored chat responses are then transmitted back to users' client computing devices where the responses are presented to the user. The techniques discussed herein may be used to manage emotionally intelligent chat engines in a manner that keeps users engaged.

### BRIEF DESCRIPTION OF THE DRAWINGS

The disclosed examples are described in detail below with reference to the accompanying drawing figures listed below:

FIG. 1 is a block diagram illustrating an exemplary computing device for collecting and the providing user and environmental data.

FIG. 2 is a block diagram of a networking environment for providing an emotionally intelligent chat engine on client computing devices.

FIG. 3 is a block diagram of a chat engine server providing a chat response to a client computing device using a multi-layered selector component.

FIG. 4 is a flow chart diagram of a work flow for providing chat responses for a chat engine presented on a client computing device.

FIG. 5 is a flow chart diagram of a work flow for providing chat responses for a chat engine presented on a client computing device.

FIG. 6 is a flow chart diagram of a work flow for providing chat responses for a chat engine presented on a client computing device.

FIG. 7 is user interface diagram of a user interface for a chat conversation on a client computing device.

Corresponding reference characters indicate corresponding parts throughout the drawings.

### DETAILED DESCRIPTION

Examples disclosed herein are directed to systems, devices, methods, and computer-storage memory embodied with executable instructions for providing an interactive and emotionally cognizant chat engine on a smart phone, mobile tablet, networked toy, car computer, or other client computing device. Using the disclosed examples, a client computing device is equipped with a chat engine that can understand and interpret the emotional state and current environment of a user. The emotional state may be determined, in some examples, through the interpretation of text, video, images, speech, audio, touches, or other information captured on the client device from the user. For example, the tone of a user's voice may indicate that the user is in an excited state, the user's facial expression may indicate the user is upset, the user's choice in text may indicate the user is disinterested in a topic, or the like. To create an emotionally intelligent chat engine, the examples disclosed herein capture various relevant user and environmental data on the client device, communicate the captured user and environmental data to a chat engine server for determining the user's emotional state, generate a chat response based on the user's emotional state, and present the generated chat response to the user.

In some examples, a user's input data and environmental data are analyzed, either by a client device (in some examples) or by a chat engine server (in other examples) to determine the user's emotional state. Chat responses for interacting with the user in text, verbal, animation, or video conversation are selected or generated using a multi-layer sequence of response selection components that access various indexes of information to generate appropriate chat responses based on user input and environmental data. A learning module may be used to select which of the generated responses to provide a user, taking into account the user's detected emotional state and/or environment.

The selected or generated responses are tailored based on the emotional state of the user in order to provide a more communicative and more emotionally intelligent chat experience than conventional digital assistants provide. Again, today's digital assistants do not take into account the emotional state of the user. Using the various examples disclosed herein, chat responses are specifically to fit the user's emotional state. For example, when the user is upset, certain chat responses will be used (e.g., “What's wrong?” or “Do you want to play to try and cheer up?”). Providing emotionally intelligent chat responses enhances the user experience by providing a more accurate way to communicate with users on a client device.

Also, by recognizing the emotions of the user, the examples disclosed herein can better communicate with young children who may require sanitization of chat responses, simplification of chat responses to stay interested in using the client device, encouragement throughout the chat experience (e.g., for shy or upset children), or other emotional stimulation to keep the child engaged. For example, children are often reluctant to interact with devices (or adults) when they are upset. So the disclosed examples may first detect the mood of the child, and then provide chat responses (e.g., sing a song, ask what is wrong, tell a joke, etc.) in an attempt to cheer up the child, which, if successful, will likely keep the child engaged with the chat engine. Along these same lines, other examples disclosed herein provide a way to recognize when a child is losing interest in the chat experience, and consequently simplify subsequent chat responses to reengage the child.

While examples dealing with children are disclosed herein, the disclosed examples are not limited to just detecting emotions and communicating with children. The disclosed examples may determine different emotional states specific to virtually any age group, class, or other grouping of people, and use these specific states to tailor the chat response accordingly. For instance, chat responses attempting to uplift a senior user may differ from those used to uplift middle-aged, teenaged, and adolescent users. Thus, the disclosed examples may be used to recognize and use a user's emotional state to generate chat responses that keep the user in a particular state (e.g., happy) or interacting with the client device.

For purposes of this disclosure, a “chat” or “chat conversation” refers to an electronic interaction between a user and a computing device, such as, for example but without limitation, a sequence of exchanged text, video, audio, etc. For example, a toy may interactively speak with a child user. An avatar presented on a computer screen may speak, present text, or carry out animations with a user. Chat responses may be communicated through a car or other vehicle's audio system. A “chat engine” refers to the entire device and software components for presenting the chat conversation to the user, including the front-end user experience, middle chat response software, and backend databases of data used to present chat responses.

To determine a user's emotional state, some examples capture a user's text, voice, image, video, or other user data on a client computing device and communicate the captured user data to a chat engine server. This captured data is collectively referred to herein as “user input data” or simply “user data.” Examples of user input data include, without limitation, text input from the user, speech and other audio from the user, images or video of the user or the user's environment, user touches on a touch screen device, and any other information either input by the user or captured from the user and their environment.

As referenced herein, a “user profile” refers to an electronically stored collection of information related to the user. Such information may include the user's name, age, gender, height, weight, demographics, current location, residency, citizenship, family, friends, height, weight, age, gender, schooling, occupation, hobbies, skills, interests, Web searches, health information, birthday, anniversary, celebrated holidays, moods, emotional states, and any other personalized information associated with the user. The user profile includes profile elements that may be static (e.g., name, birthplace, etc.) and dynamic elements that change over time (e.g., residency, age, etc.). The user profile may be built through probing questions to the user or through analyzing the user's behavior on one or more client computing devices.

As referenced herein, “environmental data” refers to information relating to a user's surrounding environment, location, or other activity being performed, as captured by one or more sensors or electrical components of a computing device. Environmental data may include information detected from one or more sensors of a client device. For example, a global positioning system (GPS) sensor in a client device may determine the user's location, an accelerometer may determine the user's movement, a gyroscope may determine the user's orientation, a thermometer may determine the temperature at a user's location, and so forth. Environmental may also include information retrieved from user input data, such as, for example but without limitation, the background of an image or video, the background noise of an audio recording, speech from other users in an audio recording, or other non-user specific data or portions of the user input data.

Moreover, in some examples, environmental data may also or alternatively include previously captured historical images, videos, audio files, sensor data, or other information captured by client computing devices of other users who are either related to the user through different Web relationships (e.g., social networking sites, contact lists, etc.); asked similar questions or made similar statements as the user; share common user profile parameters as the user; or are otherwise symbiotically connected to the user in some manner. In some examples, environmental data is identified in the user input data (e.g., background noise in audio, portions of images or videos, etc.) by a chat engine server receiving the user input data from a client computing device over a network. In alternative examples, the environmental data may be parsed from the user input data by the client computing device and sent to the chat engine server separately.

As disclosed in more detail below, emotional states for users may be determined based on the user input data either alone or in combination with captured environmental data. For example, speech recognition of a user's voice (user data) may reveal that the user is in an elated and curious state while at a location (environmental data) where other users are typically amazed, and consequently, the user's emotional state may determined to be some combination of elation, curiosity and amazement. In some examples, the chat engine server uses the user input data and/or the environmental data to determine the emotional state of the user, and then uses the emotional state to influence the chat responses provided to the user.

Emotional states may include any designation of emotion, such as, for example but without limitation various levels of joy (e.g., ecstasy, elation, cheerfulness, serenity, delight); anticipation (vigilance, curiosity, interest, expectancy, attentiveness); fear (terror, panic, fright, dismay, apprehension, timidity); surprise (astonishment, amazement, uncertainty, distraction); sadness (grief, sorrow, dejection, gloominess, pensiveness); disgust (loathing, revulsion, aversion, dislike, boredom); anger (fury, rage, hostility, annoyance); trust (admiration, acceptance, tolerance); or other type of emotion.

The disclosed examples may indicate emotional states as one emotion (e.g., dejection) or a combination of emotions (e.g., gloominess, boredom, annoyance) that may be equally (e.g., 33% gloominess, 33% boredom, 33% annoyance) or disproportionately (e.g., 50% gloominess, 10% boredom, 40% annoyance) weighted in order to signify an emotional state. Other examples may determine a user's emotional state to be only related to one or a combination of a few emotional states, such as happiness, anger, sadness, etc. Some examples may assign weightings to the determined emotions based on what emotion appears to be more dominant from the user input or environmental data; whether the emotion was indicated from user input or environmental data (e.g., more deference may given to emotions determined from user input data, in some examples); or through various other weighting schemes.

Having generally provided an overview of some of the disclosed examples, attention is drawn to the accompanying drawings to further illustrate some additional details. The illustrated configurations and operational sequences are provided for to aid the reader in understanding some aspects of the disclosed examples. The accompanying figures are not meant to limit all examples, and thus some examples may include different components, devices, or sequences of operations while not departing from the scope of the disclosed examples discussed herein. In other words, some examples may be embodied or may function in different ways than those shown.

Aspects of the disclosure create a better chat user experience by tailoring chat responses to the user's emotional state. Understanding the user's emotional state and tailoring chat messages accordingly drastically expands the capabilities of conventional computing devices, providing a platform where emotionally cognizant applications can exist. Additionally, the emotion-detection techniques disclosed herein improve user efficiency via chat user interfaces, increase user device interaction, increased user interaction performance, and reduce chat engine errors (thereby reducing processing and memory waste).

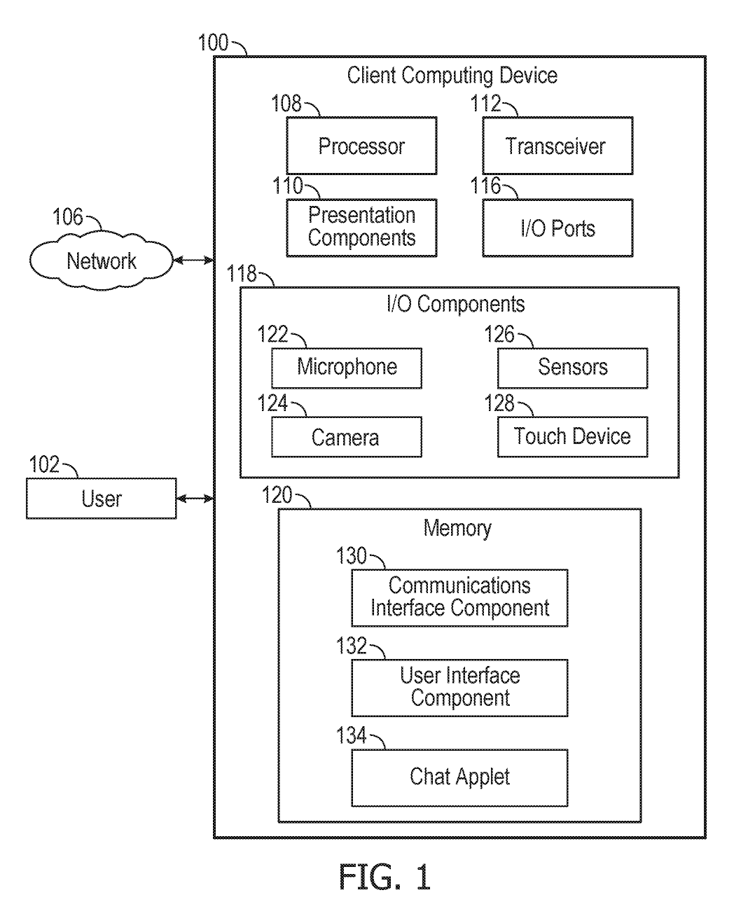

Referring again to FIG. 1, an exemplary block diagram illustrates a client computing device 100 configured to capture and transmit user and environmental data. The client computing device 100 represents any device executing instructions (e.g., as application programs, operating system functionality, or both) to implement the operations and functionality described herein associated with the computing device 100. In some examples, the client computing device 100 has at least one processor 108, one or more presentation components 110, a transceiver 112, one or more input/output (I/O) ports 116, one or more I/O components 118, and computer-storage memory 120. More specifically, the computer-storage memory 120 is embodied with machine-executable instructions comprising a communications interface component 130, a user interface component 132, and a chat applet 134 that are each executable by the processor 108 to carry out disclosed functions below.

The client computing device 100 may take the form of a mobile computing device or any other portable device, such as, for example but without limitation, a mobile telephone, laptop, tablet, computing pad, netbook, gaming device, and/or portable media player. The client computing device 100 may also include less portable devices such as desktop personal computers, kiosks, tabletop devices, industrial control devices, wireless charging stations, and electric automobile charging stations. Further still, the client computing device 100 may alternatively take the form of an electronic component of a vehicle (e.g., a vehicle computer equipped with cameras or other sensors disclosed herein); an electronically equipped toy (e.g., a stuffed animal, doll, or other child character equipped with the electrical components disclosed herein); or any other computing device. Other examples may incorporate the client computing device 100 as part of a multi-device system in which two separate physical devices share or otherwise provide access to the illustrated components of the computing device 100.

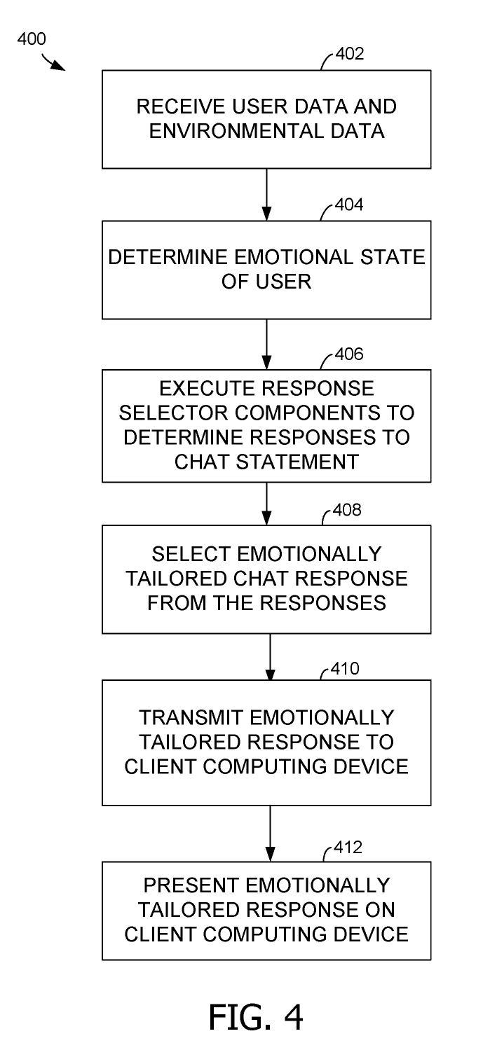

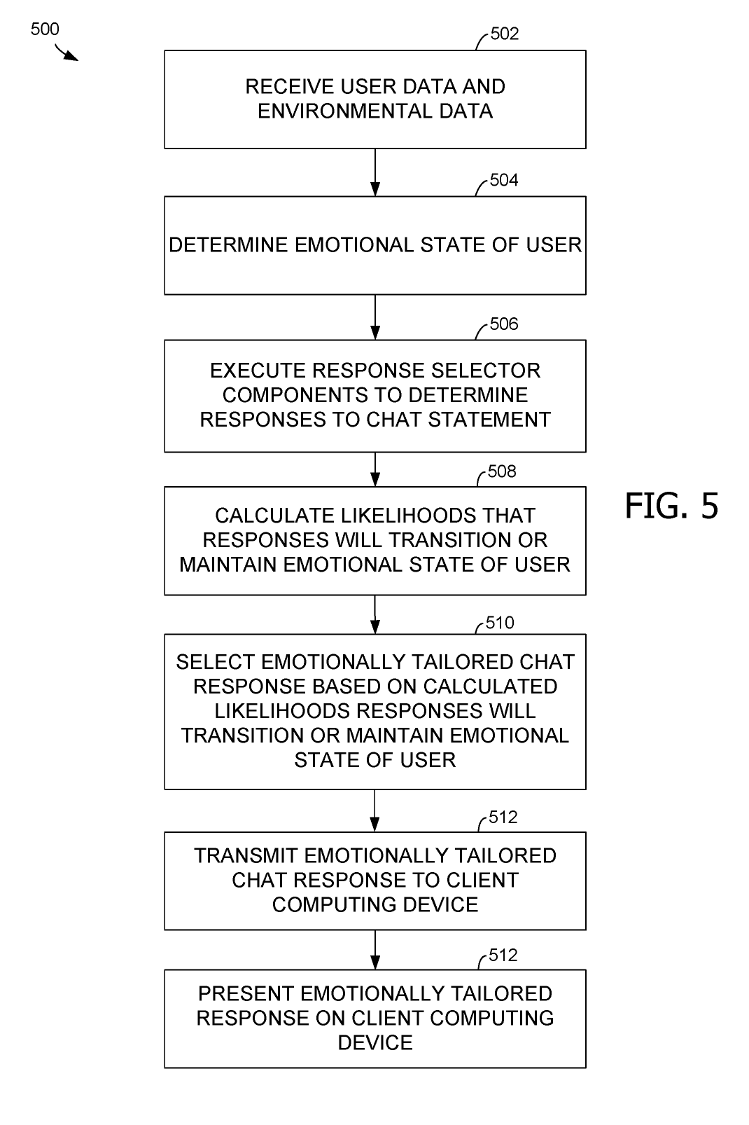

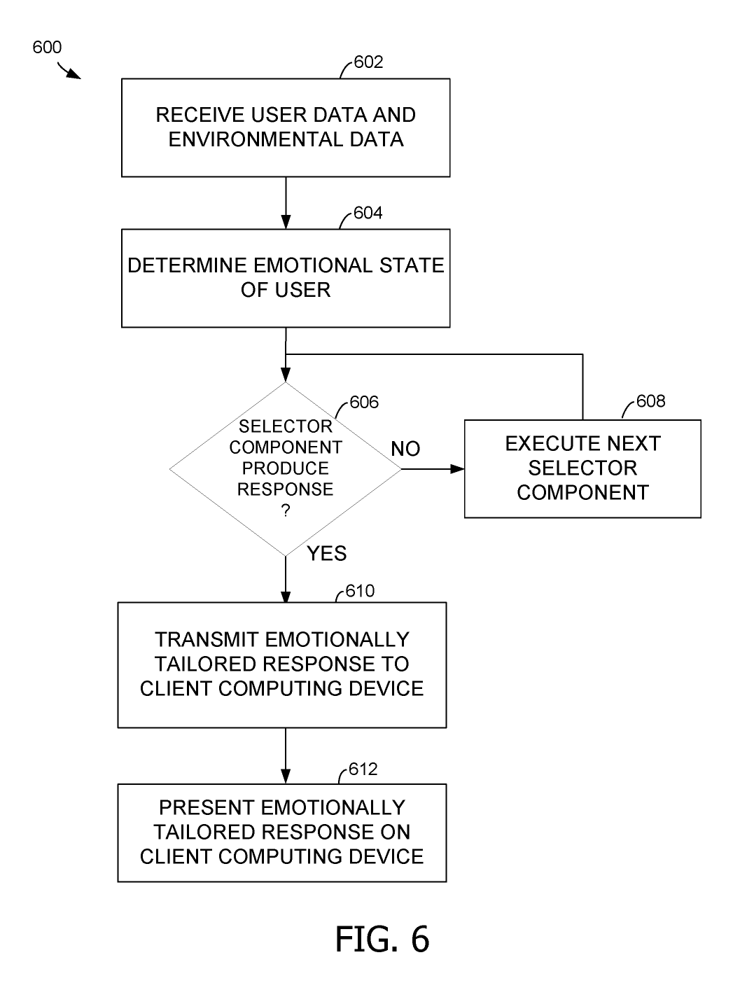

The processor 108 may include any quantity of processing units, and is programmed to execute computer-executable instructions for implementing aspects of the disclosure. The instructions may be performed by the processor or by multiple processors within the computing device, or performed by a processor external to the computing device. In some examples, the processor 108 is programmed to execute instructions such as those illustrated in accompanying FIGS. 4-5. Additionally or alternatively, some examples may program the processor 108 present a chat experience in a user interface (“UI”), e.g., the UI shown in FIG. 6. Moreover, in some examples, the processor 108 represents an implementation of analog techniques to perform the operations described herein. For example, the operations may be performed by an analog client computing device 100 and/or a digital client computing device 100.

The presentation components 110 visibly or audibly present information on the computing device 100. Examples of display devices 110 include, without limitation, computer monitors, televisions, projectors, touch screens, phone displays, tablet displays, wearable device screens, televisions, speakers, vibrating devices, and any other devices configured to display, verbally communicate, or otherwise indicate chat responses to a user. In some examples, as mentioned above, the client computing device 100 may be a child's electronic toy or doll that includes speakers capable of playing audible chat responses to the child. In other examples, the client computing device 100 is a smart phone or a mobile tablet with graphical user interfaces (GUIs) displaying a character or assistant (e.g., a talking teddy bear, an image of an adult, etc.) that may present text chat responses on a screen and/or audible chat responses through speakers to the child. In still other examples, the client computing device 100 is a computer in a car that presents audio chat responses through a car speaker system, visual chat responses on display screens in the car (e.g., situated in the car's dash, within headrests, on a drop-down screen, or the like), or a combination thereof. Other examples may present the disclosed chat responses through various other display or audio presentation components 110.

The transceiver 112 is an antenna capable of transmitting and receiving radio frequency (“RF”) signals. One skilled in the art will appreciate and understand that various antennae and corresponding chipsets may be used to provide communicative capabilities between the client computing device 100 and other remote devices. Examples are not limited to RF signaling, however, as various other communication modalities may alternatively be used.

I/O ports 116 allow the client computing device 100 to be logically coupled to other devices and I/O components 118, some of which may be built in to client computing device 100 while others may be external. Specific to the examples discussed herein, I/O components 118 include a microphone 122, a camera 124, one or more sensors 126, and a touch device 128. The microphone 1224 captures audio from the user 102. The camera 124 captures images or video of the user 102. The sensors 126 may include any number of sensors on or in a mobile computing device, electronic toy, gaming console, wearable device, television, vehicle, or other computing device 100. Additionally, the sensors 126 may include an accelerometer, magnetometer, pressure sensor, photometer, thermometer, global positioning system (“GPS”) chip or circuitry, bar scanner, biometric scanner (e.g., fingerprint, palm print, blood, eye, or the like), gyroscope, near-field communication (“NFC”) receiver, or any other sensor configured to capture data from the user 102 or the environment. The touch device 128 may include a touchpad, track pad, touch screen, other touch-capturing device capable of translating physical touches into interactions with software being presented on, through, or by the presentation components 110. The illustrated I/O components 118 are but one example of I/O components that may be included on the client computing device 100. Other examples may include additional or alternative I/O components 118, e.g., a sound card, a vibrating device, a scanner, a printer, a wireless communication module, or any other component for capturing information related to the user or the user's environment.

The computer-storage memory 120 includes any quantity of memory associated with or accessible by the computing device 100. The memory area 120 may be internal to the client computing device 100 (as shown in FIG. 1), external to the client computing device 100 (not shown), or both (not shown). Examples of memory 120 in include, without limitation, random access memory (RAM); read only memory (ROM); electronically erasable programmable read only memory (EEPROM); flash memory or other memory technologies; CDROM, digital versatile disks (DVDs) or other optical or holographic media; magnetic cassettes, magnetic tape, magnetic disk storage or other magnetic storage devices; memory wired into an analog computing device; or any other medium for encoding desired information and for access by the client computing device 100. Memory 120 may also take the form of volatile and/or nonvolatile memory; may be removable, non-removable, or a combination thereof; and may include various hardware devices (e.g., solid-state memory, hard drives, optical-disc drives, etc.). Additionally or alternatively, the memory 120 may be distributed across multiple client computing devices 100, e.g., in a virtualized environment in which instruction processing is carried out on multiple devices 100. For the purposes of this disclosure, “computer storage media,” “computer-storage memory,” and “memory” do not include carrier waves or propagating signaling.

The computer-storage memory 120 stores, among other data, various device applications that, when executed by the processor 108, operate to perform functionality on the computing device 100. Examples of applications include chat applications, instant messaging applications, electronic-mail application programs, web browsers, calendar application programs, address book application programs, messaging programs, media applications, location-based services, search programs, and the like. The applications may communicate with counterpart applications or services such as web services accessible via the network 106. For example, the applications may include client-operating applications that correspond to server-side applications executing on remote servers or computing devices in the cloud.

Specifically, instructions stored in memory 120 comprise a communications interface component 130, a user interface component 132, and a chat applet 134. In some examples, the communications interface component 130 includes a network interface card and/or a driver for operating the network interface card. Communication between the client computing device 100 and other devices may occur using any protocol or mechanism over a wired or wireless connection, or across the network 106. In some examples, the communications interface component 130 is operable with RF and short-range communication technologies using electronic tags, such as NFC tags, Bluetooth® brand tags, or the like.

In some examples, the user interface component 132 includes a graphics card for displaying data to the user and receiving data from the user. The user interface component 132 may also include computer-executable instructions (e.g., a driver) for operating the graphics card to display chat responses and corresponding images or audio on or through the presentation components 110. The user interface component 132 may also interact with the various sensors 126 to both capture and present information through the presentation components 110.

The chat applet 134, when executed, presents chat responses through the presentation components 110. In some examples, the chat applet 134, when executed, retrieves user data and environmental data captured through the I/O components 118 and communicates the retrieved user and environmental data over the network to a remote server. The remote server, in some examples, operates a servlet configured to identify user emotional and/or environmental states from the communicated user data and environmental data, generate chat responses that are tailored to the emotional states, and communicate the chat responses back to the client computing device 100 for display through the presentation components 110. In other examples, the chat applet 134 may include instructions for determining the emotional or environmental state of the user 102 on the client computing device 100—instead of such determinations being made on a remote server. Determination of the emotional state of the user 102 may be performed—either by the chat applet 134 or a servlet—through recognized facial movements in captured images or videos, tonal or frequency analysis of a user's speech, facial expressions, user reactions, eye movements, body scans, micro-emotions, motions, micro-motions, and the like.

When emotional states are determined on the client computing device 100, some examples may then communicate the determined emotional state to a server, either separately or along with the environmental data also captured on the client computing device 100, for use in selecting emotionally tailored chat responses. For example, an emotional state indicating that the user 102 is ecstatic and excited—either weighted or not—may be transmitted along with the current location of the client computing device (e.g., from a GPS circuit) and recorded ambient or background noise. In response, a receiver server may generate or select an appropriate response based on the ecstatic/excited emotional state of the user and the user's location.

Additionally or alternatively, the environmental data captured by the I/O components 118 may also be analyzed, either by the client computing device 100 or a remote server, to determine various environmental events happening around the user. Background audio, images, and video may be analyzed to garner information about the surroundings of the user 102. For example, cartoons playing on a television in the background may be recognized and used to indicate that a child is watching cartoons and in an emotional state common to watching cartoons (e.g., happy). In another example, a video of the user 102 may be analyzed and a dog running in the background recognized, provoking a chat response about the dog or tailored to an emotional state common to a user 102 playing or walking a dog. In still another example, an image of the user 102 may be analyzed to uncover a beach in the background, thereby indicating that the user is on vacation. Numerous other examples may interpret environmental data in different, alternative, or additional ways to better understand the surroundings and emotional state of the user 102.

While discussed in more depth below, some examples also build and maintain a user profile for the user 102. To prepare or maintain up-to-date user profiles, the chat applet 134 or a chat servlet may be configured to periodically, responsively (e.g., after certain user interactions), spontaneously, or intermittently probe the user 102 with questions to gather information about the user 102. For example, the chat applet 134—either alone or upon direction of the chat servlet—may initially ask the user 102 for certain static (i.e., non-changing) information (e.g., birthday, birthplace, parent or sibling names, etc.) and current information that is more dynamic in nature (e.g., residence, current mood, best friend, favorite toy, etc.). For the latter (i.e., dynamic information), the chat applet 134 may probe the user 102 in the future or analyze chat conversations with the user 102 for changes to the dynamic information—to ensure such information does not go stale. For example, if a user profile previously indicated two years ago that a user 102 lives in Seattle, and the chat applet 134 recognizes that the client computing device 100 is spending more than a threshold amount of time (e.g., days a year, hours a week, etc.) in Houston, Tex., the chat applet 134 may be configured or directed by a chat servlet to ask the user 102 whether he or she lives in a new location. Such questions may be triggered by user input data (e.g., chat responses), a lapse in time, detected environmental data, emotional states of the user 102, or any other trigger.

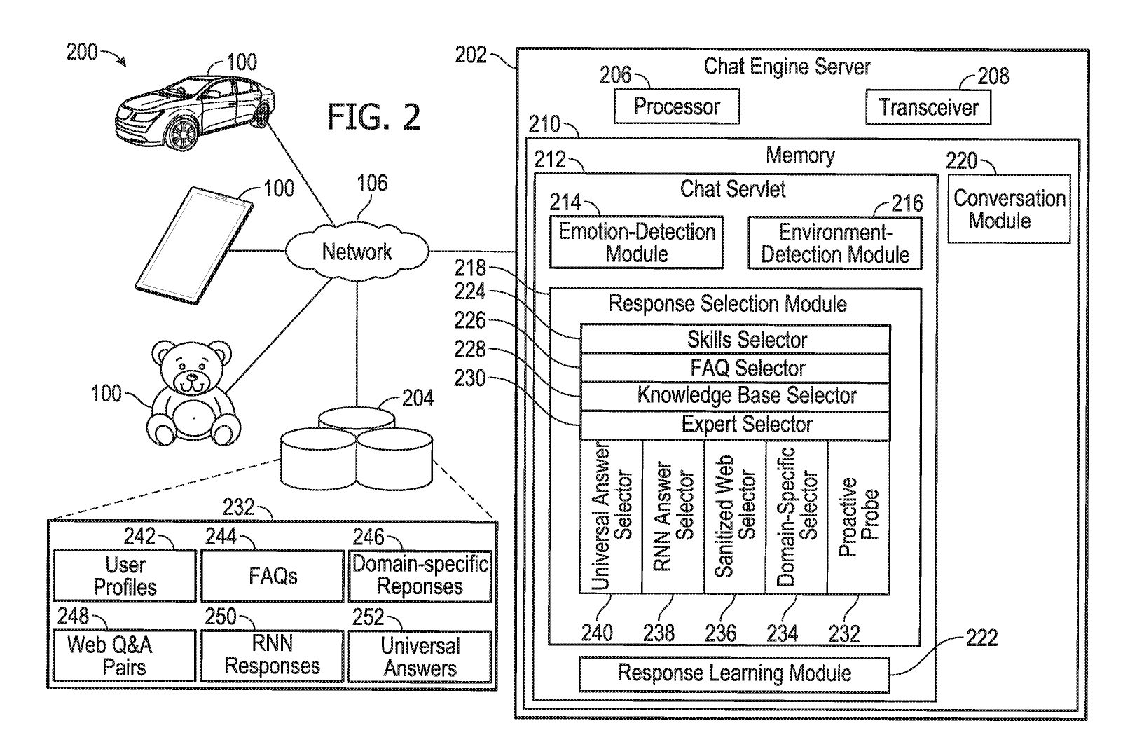

FIG. 2 is a block diagram of a networking environment 200 for providing an emotionally intelligent chat engine on client computing devices 100. The networking environment 200 includes multiple client computing devices 100, a chat engine server 202, and a database cluster 204 communicating over a network 106. In some examples, user and environmental data are communicated by the client computing devices 100 over the network 106 to the chat engine server 202, and the chat engine server 202 generates emotionally tailored chat responses that are provided back to the client computing devices 100 for presentation as part of a chat conversation to their respective users 102. The networking environment 200 shown in FIG. 2 is merely an example of one suitable computing system environment and is not intended to suggest any limitation as to the scope of use or functionality of examples disclosed herein. Neither should the illustrated networking environment 200 be interpreted as having any dependency or requirement related to any single component, module, index, or combination thereof.

The network 106 may include any computer network, for example the Internet, a private network, local area network (LAN), wide area network (WAN), or the like. The network 106 may include various network interfaces, adapters, modems, and other networking devices for communicatively connecting the client computing devices 100, the chat engine 202, and the database cluster 204. The network 106 may also include configurations for point-to-point connections. Computer networks are well known to one skilled in the art, and therefore do not need to be discussed at length herein.

The client computing devices 100 may be any type of computing device discussed above in reference to FIG. 1. To illustrate the versatility of the various examples contemplated by this disclosure, the examples shown in FIG. 2 depicts client computing devices 100 as a car, a mobile phone, and an electronic teddy bear. Each client computing device 100 may capture user and/or environmental data from their respective users and communicate the captured user and environmental data over the network 106 to the chat engine server 202 and/or the database cluster 232. To do so, each device may be equipped with a communications interface component 132, as discussed above in reference to FIG. 1. In response, the chat engine server 202 is capable of providing emotionally intelligent chat responses in a chat experience to myriad client computing devices 100 capable of communicating their respectively captured user and environmental data over the network 106. Put another way, the chat engine server 202 may control chat engine conversations on many client computing devices 100.

The client computing devices 100 may be equipped with various software applications and presentation components 110 for presenting received chat responses to their respective users. For example, the car may present text or animations on a television screen in a headrest and corresponding audio through a speaker system. The mobile phone may present a virtual assistant or child-friendly avatar on a screen and the corresponding audio through a speaker. The teddy bear may present audio through a speaker and may use lights or other animatronics (e.g., teddy bear movements) to present the chat responses. The illustrated client computing devices and the aforesaid presentation mechanisms are not an exhaustive list covering all examples. Many different variations of client computing devices 100 and presentation techniques may be used to the convey chat responses to users.

The chat engine server 202 represents a server or collection of servers configured to execute different web-service computer-executable instructions. The chat engine server 202 includes a processor 206 to process executable instructions, a transceiver 208 to communicate over the network 106, and computer-storage memory 210 embodied with at least the following executable instructions: a chat servlet 212, a conversation module 220, and a response learning module 222. The chat servlet 212 includes instructions for an emotion-detection module 214, an environment-detection module 216, and a response selection module 218. Further still, response selection module 218 comprises a multi-layered selection component consisting of a skill selector 224, an frequently asked question (“FAQ”) FAQ selector 226, a knowledge base selector 228, an expert selector 230, a proactive probe 232, a domain-specific selector 234, a sanitized web selector 236, and a universal answer selector 240—the operations of which are discussed in more detail below. While chat engine server 202 is illustrated as a single box, one skilled in the art will appreciate that the chat engine server 202 may, in fact, be scalable. For example, the chat engine server 202 may actually include multiple servers operating various portions of software that collectively generate chat responses and control chat conversations on the client computing devices 100.

The database cluster 204 provides backend storage of Web, user, and environmental data that may be accessed over the network 106 by the chat engine server 202 or the client computing devices 100 and used by the chat engine server 202 to generate emotionally tailored chat responses. The Web, user, and environmental data stored in the database cluster includes, for example but without limitation, user profiles 242, frequently asked questions (“FAQs”) 244, domain specific responses 246, question-and-answer pairs on the World Wide Web (“Web Q&A pairs”) 248, recursive neural network (“RNN”) responses 250, and universal answers 252. Additionally, though not shown for the sake of clarity, the servers of the database cluster 204 may include their own processors, transceivers, and computer-storage memory. Also, networking environment 200 depicts the database cluster 232 as a collection of separate devices from the chat engine server 202; however, examples may actually store the discussed Web, user, and environmental data shown in the database cluster 204 on the chat engine server 202.

More specifically, the user profiles 242 may include any of the previously mentioned static and dynamic data parameters for individual users. Examples of user profile data include, without limitation, a user's age, gender, race, name, location, parents, likes, interests, Web search history, Web comments, social media connections and interactions, online groups, schooling, location, birthplace, native or learned languages, proficiencies, purchase history, routine behavior, jobs, previous emotional states, religion, medical data, employment data, financial data, or virtually any unique data point specific to the user. The user profiles 242 may be expanded to encompass to virtually every aspect of a user's life. In some examples, the user profile 242 include data received from a variety of sources, such as web sites (e.g., blogs, comment sections, etc.), mobile applications, chat conversations with the user in response to proactive or reactive questioning of the chat engine, chat conversations with the user's online connections, chat conversations with similarly profiled users, or other sources. As with the types of data that may be included in the user profiles 242, the sources of such information are deeply expansive as well.

In some examples, the FAQs 244 include any question-and-answer (Q&A) pairs associated with the chat engine being presented on the client computing device 100 or the client computing device 100 itself. For example, FAQs 244 may include Q&A pairs with questions and corresponding answers related to the name of an electronic toy, virtual assistant, or avatar's name (e.g., “Teddy” for an actual teddy bear or virtual teddy bear); particular languages that the chat engine can understand; ways of better communicating with the chat engine; or other Q&A pairs particular to the chat engine itself. Such Q&A pairs may be uploaded by administrators or gathered over time based on use of the chat engine by numerous or specific users.

In some examples, the domain-specific responses 246 include specific chat responses based on various timing events and scenarios. Such events and scenarios may account for the specific day of the year (e.g., a particular holiday), time of day, calendar season, or other timing events. For example, a user's mood may routinely be different in the morning than the evening; so the domain-specific responses 246 may indicate particular responses based on the time of day. Or data stored with the domain-specific responses 246 may reflect adjustments to mood based on various timing events or scenarios. For example, detected emotional states by the emotion-detection module 214 may be adjusted from ecstatic to delightful during the morning in order to account for the general lower-energy portion of the day for a user in the morning. The domain-specific responses 246 and accompanying emotional-state weighting and adjusting data may be specific to the individual user or to a group a similar users.

In some examples, the web Q&A pairs 248 include questions and answers that are publically available on the Web. The Q&A pairs 248 may be gathered from online information and adjusted or sanitized for a particular user. For example, foul or indecent language may be removed from Q&A pairs 248 for children, politically biased language may be removed from political users favoring another political party, and the like. Information gathered for the Q&A pairs 248 may be captured from the online sources, such as, for example but without limitation, web pages, web comment sections, social media sites, or other online sources that show interactions between online users. While web Q&A pairs 248 imply actual questions being asked, for purposes of this disclosure web Q&A pairs 248 may include any association between two pieces of information on the Web. For example, social media comments about a particular topic may be associated with the topic and included as part of the web Q&A pairs 248, a popular blog comment may be associated with a topic of a particular web page, and so forth. Virtually any combination of the online information may be associated with each and stored as web Q&A pair 248.

In some examples, the RNN responses 250 include responses prepared through recursive neural network learning from information on the Web. To this end, some examples use an RNN-based web service to generate chat response that can be used in a conversation with a user. Such services, which may be implemented by the chat engine server 202 or other remote servers, operatively generate a phrase or sentence for a chat response based on a software-implemented pre-trained model that analyzes user conversation statements or questions and generates a response sentence based on the information in the Q&A pairs discussed herein. For example, a question from a user of “When is bedtime?” may cause the RNN model to generate a sentence of “Bedtime is 10:30 pm” based on information available on the web and an RNN analysis of the user's question and an index of Q&A pairs. These RNN responses 250 may be stored on database cluster 232 for future use—either for a particular user or for other users with common user profile 242 characteristics.

In some examples, the universal answers 252 include predefined chat responses that answer many different questions. Sample universal answers 252 include, for example, but without limitation, “Can you repeat that?”; “Let me think”; and “All right!” In some examples, the universal answers 252 are predefined responses that can be presented to the users when other more-specific answers cannot be generated.

In operation, users engage the client computing devices 100, which may proactively or reactively capture user and/or environmental data from the user or their surroundings. In some examples, the client computing devices 100 may be configured to proactively probe the users for information by asking questions about the users' emotional states, surroundings, experiences, or information that may be used to build or keep the user profiles 242 current. For example, a client computing device 100 may capture images of the user, read various sensors, or ask the user probing questions. Additionally or alternatively, the client computing devices 100 may reactively capture user and the environmental data upon engagement of interaction with the user. For example, a user may ask a question, open a chat engine application, or otherwise engage the chat applet 134, prompting the client computing device 100 to capture corresponding user and/or environmental data. Whether proactively or reactively obtained, user and environmental data captured on the client computing devices 100 may be transmitted to the chat engine server 202 for generation of appropriate chat conversation responses. Additionally or alternatively, some or all of the captured user and environmental data may be transmitted to the database cluster 232 for storage. For example, information that is related to a user's profile gathered by the chat applet 134 on the client computing device 100 may be stored on the database cluster 204.

The chat engine server 202 controls chat conversations on the client computing devices 100 based on the user and/or environmental data received from the client computing devices 100; the data in the database cluster 232; emotional states of the user; or a combination thereof. To this end, the chat servlet 212, in some examples, uses the emotion-detection module 214 to determine users' emotional states and the environment-detection module 216 to determine users' environments. Additionally, the chart servlet 212 executes the multi-layer response selection module 218 to generate or select chat responses to serve the client computing devices 100. The response selection module 218 may take into account the determined emotional and environmental states of the users when selecting or generating chat responses. Moreover, in some examples, the response learning module 222 provides rules or other conditions for moving users from one state (e.g., gloomy) to another state (e.g., happy) based on historical learning from previous chat conversations and corresponding emotional states—either specific to the users themselves, connected users (e.g., family, friends, social networking, etc.), users with similar user profiles 242, or strangers to the users. Using the techniques, modules, and components disclosed herein, the chat engine server 202 can provide the client computing devices 100 with conversational chat responses based on the user's emotional state and/or the user's surroundings.

In some examples, the emotion-detection module 214 determines the emotional state of the user by analyzing the user data received from the client computing device 100. To do so, the emotion-detection module 214 emotional states for users may be determined based on the user data, either alone or in combination with captured environmental data. The emotion-detection module 214 may execute instructions for analyzing the tone, frequency, pitch, amplitude, vibrato, reverberation, or other audible parameter of a user's speech in order to determine the user's emotional state. Moreover, the user's speech may be translated by the emotion-detection module 214 into text or audibly recognized for the content of what the user is saying, and the user's recognized words or phrases may be interpreted by the emotion-detection module 214 to understand the user's emotional state.

Along these same lines, user text may similarly be analyzed by the emotion-detection module 214 to understand the user's emotional state. Particular nouns, verbs, or other word choice may indicate the user's emotions, as may punctuation, capitalization, or other specifics about the text. Additionally or alternatively, the emotion-detection module 214 may include operable image-recognition instructions to analyze images or videos of a user in order to interpret the user's emotional state from the user's facial features, countenance, actions, gazes, movements, expressions, or other visually captured parameters. Additionally or alternatively, the emotion-detection module 214 may recognize other people in images, video, or audio and interpret the users' emotional states in light of the surrounding people. For example, children are generally more comfortable in the presence of their parents or siblings than in the presence of strangers; so parent and sibling presence detection—whether through text, audio, image, or video—may be interpreted by the emotion-detection module 214 to indicate a happier emotional state for the child.

Thus, the emotion-detection module 214 is flexible and can quickly determine a user's emotional state from any combination of user text, speech, images, video, either alone or in conjunction with the environmental data. The intelligence of the emotion-detection module 214 may be set by an administrator or configured to learn over time based on the user and environmental data sent from the client computing devices 100.

The environment-detection module 216 analyzes environmental data from the client computing devices 100 to determine the user's environment. Backgrounds of images, video, and audio may be analyzed to determine what is going on around the user. For example, background noise captured along with user speech may reveal to the environment-detection module 216 that the user is outdoors, at a particular location, or surrounded by particular quantities or identifiable (e.g., father, brother, etc.) people. A type of uniform being worn by the user may be recognized as an indication that the user is in school, at work, or somewhere else. Environment-recognition is not limited solely to data captured by the user. The previously discussed sensors 126 on the client computing devices 100 may also reveal the user's environment or environmental circumstances (e.g., running, at home, working, etc.).

The conversation module 220 manages the chat conversation of the client computing device 100 remotely from the chat engine server 202. In this vein, the conversation module 220 may receive the user and environmental data from client computing devices 100 and provide chat responses selected from the response selection module 218 back to the client computing devices 100.

In some examples, the response learning module 222 includes instructions operable for implementing a Markov decision process reinforcement-learning model. In some examples, the response learning module 222 uses different states made up of user needs and emotional states (e.g., positive emotion, negative emotion, or any of the emotions previously discussed); actions made up of chat responses (e.g., responses to encourage a user, responses to sympathize with a user, responses to seem understanding to the user, and the like); and rewards made up of desired changes in emotional states (e.g., from gloomy to delighted). The response learning module 222 may then calculate the likelihood of achieving the rewards (i.e., emotional state transition) based on the different combinations of states and actions achieving the rewards with this or other users in the past. Then, the response most likely able to achieve the emotional transition may be selected by the response learning module 222.

The response selection module 218 includes instructions operable to select or generate chat responses based on the user data, environmental data, emotional state, and detected environment of the user. In some examples, the response selection module 218 executes a multi-layered selection component comprising the skills selector 224, the FAQ selector 226, the knowledge base selector 228, the expert selector 230, the proactive probe 232, the domain-specific selector 234, the sanitized web selector 236, the RNN answer selector 238, and the universal answer selector 234. These selector components 224-240 represent instructions for different levels of focus of analysis of a user's chat statement or question on a client computing device 100, and the various selector components 224-240 may access the disclosed information stored in the database cluster 232 to provide chat responses mentioned herein. Any combination of the disclosed selector components 224-240 may be used, as may additional or alternative selector components.

For a given user input statement, the selector components 224-240 may proceed through several different layers to generate one or more possible chat responses.

In other examples, the selector components 224-240 sequentially execute the skills selector component 224, the FAQ selector 226, the knowledge base selector 228, and the expert selector 230, and then execute in parallel the proactive probe 232, the domain-specific selector 234, the sanitized web selector 236, the RNN answer selector 238, and the universal answer selector 240. In other examples, the selector components 224-240 sequentially execute the skills selector component 224, the FAQ selector 226, the knowledge base selector 228, the expert selector 230, the proactive probe 232, the domain-specific selector 234, the sanitized web selector 236, the RNN answer selector 238, and the universal answer selector 240. Other examples may execute the selector components 224 in any other combination of sequential or parallel processing.

In some examples, the response selection components 224 sequentially process a chat statement through the various selectors 224-240 until a chat response is generated or identified, and the generated or identified chat response is provided back to the client computing device 100. For example, if the skills selector 224 identifies a chat response, the conversation module 220 transmits that chat response to the client computing device without having to process a user's chat statement through the rest of the selector components 226-240. In this manner, the multi-layer selector components 224 operate as a filtering model that uses different layers to come up with a chat response.

Additionally or alternatively, the response selection components 224-240 may each generate possible chat responses to use in a chat conversation, and then the conversation module may select a response based on the user's emotional state, environmental state, and/or the rewards of each response calculated by the response learning module 222. For example, the selectors 224-240 may generate nine possible chat responses (e.g., one by each selector) based on the user data and corresponding emotional and environmental states respectively determined by the emotion-detection module and the environment-detection module, as well as the user profile data 242 of the user. In some examples, the response learning module 222 ranks each possible response to determine the likelihood that the response will either transition a user from one emotional state to another (e.g., from gloomy to happy) or will keep the user in a given emotional state (e.g., stay happy). Based on these rankings, the conversation module 220 may select the appropriate response to provide the user.

Looking at the selector components 224-240 in more detail, the skills selector 226 determines whether a user chat statement requires a particular skill. The skills selector 226 may include a set of predefined skills, such as singing a song, telling a funny story, talking about the current weather, and the like. User chat statements are analyzed by the skills selector 226 to determine whether one of its predefined skills may serve as a response to the user data. If so, the skills selector 224 generates a possible chat response based on the predefined skill. For example, if a user commands “Sing a song,” the skills selector may generate a response of singing a particular song.

The FAQ selector 226 analyzes user chat statements and determines whether the user is asking questions specific to the chat engine being presented. For example, a chat engine may appear as a cartoon character having a specific name, sex, age, family, favorites, or other characteristic. If a user is asking questions related to the cartoon character, FAQ selector 226 will select a response from the FAQs 244 based on the knowledge base of information for the chat engine stored as FAQs 244 in the database cluster 204. Selection of possible chat responses from FAQ selector 226 may be carried out using a ranking model of the knowledge base of information related to the chat engine. That is, the FAQ selector 226 may regard the user question as a query and the questions in the knowledge base of the FAQs 244 as candidate documents that are ranked. The FAQ selector 226 may then select the most relevant question in the knowledge base will chosen as a chat response to a user's chat question or statement.

The knowledge base selector 228 is a knowledge-based index that contains some specific knowledge base or graph for target users. For example, if the users are children, the knowledge base may include 100,000 chat responses tailored to children, such as statements about animals, plants, Earth, etc. If a user user is asking for questions in this scope, the knowledge base selector 228 selects a response from the knowledge base as a chat response. Moreover, the chat responses in the knowledge base may also be ranked and selected according such rankings.

The expert selector 230 determines whether the user's chat statements require another person or a particular expert to answer. To do so, the expert selector 230 may maintain a set of potential experts for a given user, or may access the user profiles 242 in the database cluster 232 for such information. When a user's chat statement indicates the user needs expert knowledge (e.g., “How do I stop the faucet from leaking?”), the expert indicator recommends an appropriate person to contact (e.g., “Call Joe the Plumber”). Or, in some examples, if chat responses cannot be generated by other selector components 224-228 and 232-240, either processed before or in parallel, the expert selector 230 may be configured to recommend that the user contact a trusted person (e.g., “Ask your father”).

Selector components 224-240 may operate either together in one processing layer or sequentially as multiple layers. These layered selector components 224-240 include a proactive probe 232 that contains questions to probe the user with questions or statements that do not necessarily answer a user's question but that may progress the chat conversation to illicit chat statements from the user that the response selection module 218 can answer. Sometimes a chat conversation may stall, so the proactive probe 232 may be used to progress the conversation beyond the stalling point, asking questions like “How are you doing?” or “How was school today?” that do not necessarily answer any particular of the user but instead get the user to continue talking to the chat engine.

The domain-specific selector 234 contains some specific patterns of behavior or other scenarios for target users, such as children, elders, sports enthusiasts, etc. For example, children typically wake up in the morning, go to bed in the evening, eat around 7:00 pm, etc. The domain-specific selector 234 may select or generate a response if part of a user's chat statement or environmental data mentions one of these scenarios or patterned behavior. To identify such patterns, the domain-specific selector 234 may access information in the user profiles 242 to better understand the user.

The sanitized web selector 236 is built from the domain-specific responses 246, Web Q&A pairs 248, or other Web data. In some example, such Web data may include web forums and corresponding online discussion threads that can be mined for Q&A pairs 248. For a given chat statement from a user, the domain-specific responses 246, Web Q&A pairs 248, or other Web data may be analyzed to identify or generate a response in two steps, in some examples. First, the sanitized web selector 236 finds the most similar question to the chat statement of the user, and second the sanitized web selector 236 finds the most relevant response to the most similar question. Selection of these questions and responses may take into account the user's profile 242 and environmental data. Moreover, the selected response may be sanitized for particular users (e.g., children, religious people, etc.) by removing or replacing foul or indecent language from the Web data before providing such information to the user as a chat response.

The RNN answer selector 238 executes an RNN procedure to generate chat responses from a collection of online information. Given a chat statement from a user, the RNN answer selector 238 may generate a response sentence based on a pre-trained RNN model. The RNN answer selector 238 may use predetermined RNN responses 250 or may be configured to generate chat responses on the fly by analyzing various sources of online information (e.g., web pages, social networking application, etc.). Some examples use an RNN procedure that predicts a “best” chat response to provide back to a user in a chat conversation. In some examples, the RNN procedure reads an input chat statement from the user, one word or phrase at a time, and generates an RNN response 250 one word or phrase at time. The RNN procedure may be trained, in some examples, through back-propagation on how to generate RNN responses 250. In some examples, the RNN procedure is trained to maximize cross entropy of an RNN answer 250 based on an input chat statement from the user. The RNN procedure may infer portions of the RNN responses 250 and then feed the inferred portions of RNN responses 250 to the RNN procedure as inputs to infer additional words or phrases of an RNN answer 250. In other words, RNN procedures may be run in a piecemeal manner to generate portions of an entire RNN response 250. Alternatively, some examples use a beam search to generate portions of an RNN response 250, and then feed the so-generated portions to the RNN procedure for generation of additional portions of the RNN answer 250. Additionally or alternatively, a predicted RNN answer 250 may be selected based on the probability of a sequence of inferred or generated portions of an RNN answer 250. For example, a chat conversation from a user that includes two portions: (1) the first person utters “ABC,” and (2) another replies “WXYZ.” The RNN procedure may be trained to map—or associate—“ABC” to “WXYZ.”

The universal answer selector 240 provides universal answers that may be presented in virtually any scenario in case other chat responses cannot be generated. For example, statements like “Can you repeat that?”; “Let me think”; and “All right!” may be provided to the user after virtually any chat statement. The databank of universal answers 252 on the database cluster 232 may be accessed to provide such responses. In some examples, the universal answers 252 are provided when no other chat response can be generated or identified for a given chat statement.

The response learning module 222 includes instructions operable for implementing a Markov decision process reinforcement-learning model. In some examples, the response learning module 222 uses different states made up of user needs and emotional states (e.g., positive emotion, negative emotion, or any of the emotions previously discussed); actions made up of chat responses (e.g., responses to encourage a user, responses to sympathize with a user, responses to seem understanding to the user, and the like); and rewards made up of desired changes in emotional states (e.g., from gloomy to delighted). The response learning module 222 may then calculate the likelihood of achieving the rewards (i.e., emotional state transition) based on the different combinations of states and actions achieving the rewards with this or other users in the past. In some examples, the response most likely able to achieve the emotional transition may be selected by the response learning module 222. Put another way, the response learning module 222 analyzes the possible effectiveness of the potential chat responses generated by the multi-layered selector components 224-240 and selects a response to provide to the user based on the determined ability of the group of responses either transition a user's emotional state or maintain the user's emotional state. For example, if the response learning module 222 has five or more possible responses to choose from and a user is determined to be in an excited emotional state, the response most likely to keep the user in the excited state may be selected. In another example, if the response learning module 222 has five or more possible responses and the user is in a gloomy emotional state, the response learning module 222 may prompt the selection of the generated response from the multi-layered selector component most likely to improve the user's mood, or that will most likely improve the user's mood the most based on the calculated likelihoods of transitioning, adjusting, or maintaining a user's emotional state.

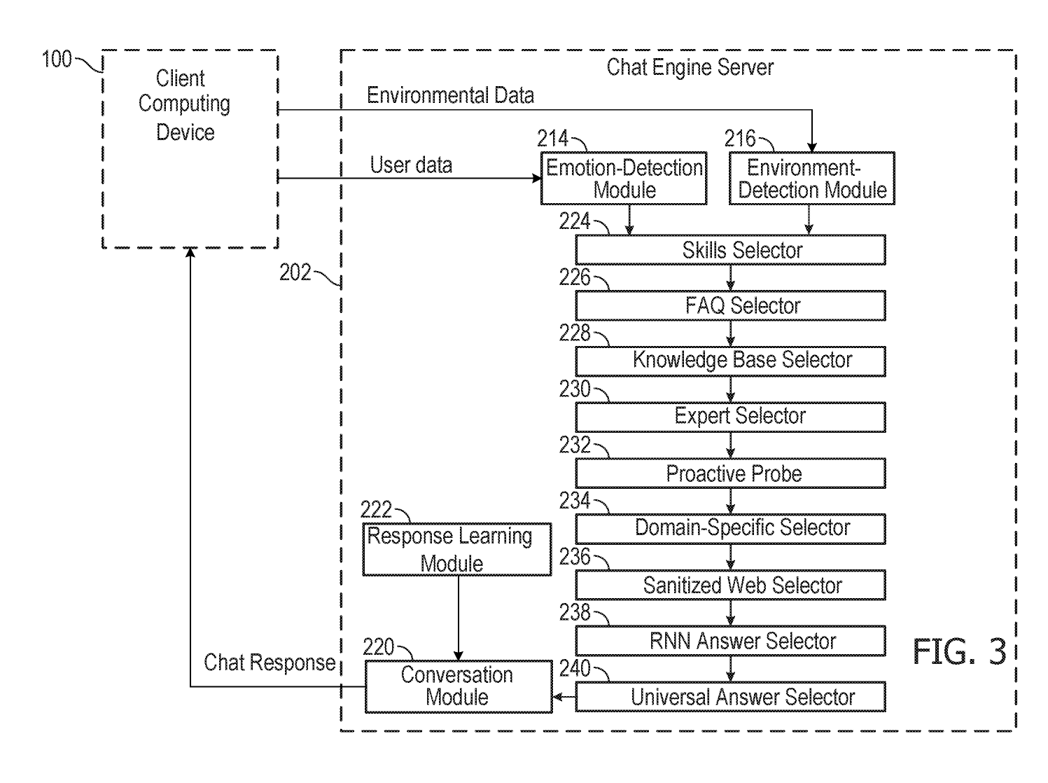

FIG. 3 illustrates a block diagram of the chat engine server 202 providing a chat response to a client computing device 100 using multi-layered selector components. The client computing device 100 provides environmental data and user data to the chat engine server 202. In some examples, the environmental data is processed by the environment-detection module 216 to identify the user's particular environmental circumstances (e.g., at home, at work, running, in a car, going to bed, etc.). The user data may include a chat statement from the user and or audio, visual, or sensor data captured of the user. In some examples, the emotion-detection module 214 processes the user data to determine the user's current emotional state (e.g., happy, sad, gloomy, 20% delighted, etc.). The user data, environmental data, determined environmental circumstances, determined emotional state, or any combination thereof may be provided to the multi-layered selector components 224-240 in order to generate one or more chat responses to provide the user. If multiple chat responses are generated by components 224-240, one preferred chat response may be selected by the conversation module 220 based on the rewards of the multiple responses calculated by the learning module 222 for either transitioning a user from one emotional state to another (e.g., cheer the user up) or for ensuring the provided chat response aligns with the user's current emotional state (e.g., selection of a response most likely to keep an ecstatic user ecstatic or otherwise happy).

In some examples, to generate chat responses, the illustrated example sequentially processes the chat statement through the various selector components 224-240. The various selector components 224-240 may also take into account the determined emotional state and environmental circumstances, as determined by the emotion-detection module 214 and environment-detection module 216, respectively. As shown, in some examples, the following processing order is used to identify chat responses based on at least the chat statement: the skills selector 224, the FAQ selector 226, the knowledge base selector 228, the expert selector 230, the proactive probe 232, the domain-specific selector 234, the sanitized web selector 236, and the universal answer selector 240. In some examples, processing by the selector components 224-240 stops when one of the components identifies or generates a chat response, and then the conversation module 220 provides the so-identified or so-generated chat response to the client computing device 100. In other examples, possible chat responses are collected from multiple or all of the selector components 224-240, and the conversation module 220 selects one to provide the client computing device 100 based on the outcome reward rankings calculated by the response learning module 222. In either scenario, the chat response selected by the conversation module 220 is eventually provided back to the client computing device 100 for presentation to the user, and the procedure may be repeated throughout a chat conversation.

FIG. 4 is a flow chart diagram of a work flow 400 for providing chat responses for a chat engine presented on a client computing device 100. Initially, as shown at block 402, user data and environmental data is communicated from the client computing device 100 and received at a chat engine server 202. Using the various techniques disclosed herein, the chat engine server 202—or, in some examples, the client computing device 100—determines the emotional state of the used based on the user data, either alone or in conjunction with the environmental data, as shown at block 404. As shown at block 406, the chat engine server 202 executes the response selector components described herein, either in parallel with each other, in sequence, or a combination thereof, to determine one or more possible chat responses to provide the user. The selector components may include the skills selector 224, the FAQ selector 226, the knowledge base selector 228, the expert selector 230, the proactive probe 232, the domain-specific selector 234, the sanitized web selector 236, the RNN answer selector 238, and the universal answer selector 240 discussed herein or other selecting components capable of identifying chat responses based on the user chat statements. One of the possible chat responses generated by the response selector components may be selected based on the user's emotional state or the environmental data, as shown at block 408. The chat engine server transmits the selected emotionally tailored chat response to the client computing device 100, as shown at block 410. And the client computing device 100 presents the selected emotionally tailored response to the user.

FIG. 5 is a flow chart diagram of a work flow 500 for providing chat responses for a chat engine presented on a client computing device 100. Initially, as shown at block 502, user data and environmental data is communicated from the client computing device 100 and received at a chat engine server 202. Using the various techniques disclosed herein, the chat engine server 202 determines the emotional state of the used based on the user data, either alone or in conjunction with the environmental data, as shown at block 504. The response selector components 224-240 disclosed herein are executed to determine one or more potential chat responses to the user's chat statement, as shown at block 506. For each potential chat response, a response learning module 222 calculates the likelihood the response will either transition and/or maintain the user's current emotional state, as shown at block 508. Such calculations may be performed through execution of a computer-implemented Markov decision procedure that analyzes different states made up of user needs and emotional states (e.g., positive emotion, negative emotion, or any of the emotions previously discussed); actions made up of chat responses (e.g., responses to encourage a user, responses to sympathize with a user, responses to seem understanding to the user, and the like); and rewards made up of desired changes in emotional states (e.g., from gloomy to delighted). Other techniques may alternatively be used to determine the likelihood that a potential chat response may transition or maintain the user's emotional state. In some examples, one emotionally tailored chat response is selected from the potential chat responses based on the calculated emotional state transition or maintenance likelihoods, as shown at block 510. The selected emotionally tailored chat response transmitted back to the client computing device of the user and presented to the user, as shown at blocks 510 and 512, respectively.

FIG. 6 is a flow chart diagram of a work flow 600 for providing chat responses for a chat engine presented on a client computing device 100. Initially, as shown at block 602, user data and environmental data is communicated from the client computing device 100 and received at a chat engine server 202. Using the various techniques disclosed herein, the chat engine server 202—or, in some examples, the client computing device 100—determines the emotional state of the used based on the user data, either alone or in conjunction with the environmental data, as shown at block 604. In some examples, the multi-layered selector components are sequentially executed to determine an emotionally tailored response to a user's chat statement in the user data. Decision block 606 and block 608 show that each selector component (e.g., the skills selector 224, the FAQ selector 226, the knowledge base selector 228, the expert selector 230, the proactive probe 232, the domain-specific selector 234, the sanitized web selector 236, the RNN answer selector 238, and the universal answer selector 240) are sequentially executed—sometimes in the just-listed order—until one of the components provides a chat response. When a component generates a response, in some examples, the selector components stop being executed (e.g., when the FAQ selector 226 generates a response, the components 236-240 are not run), and the generated response is transmitted as the emotionally tailored response back to the client computing device 100, as shown at block 610. The client computing device 100 can then present the emotionally tailored response to the user, as shown at block 612.

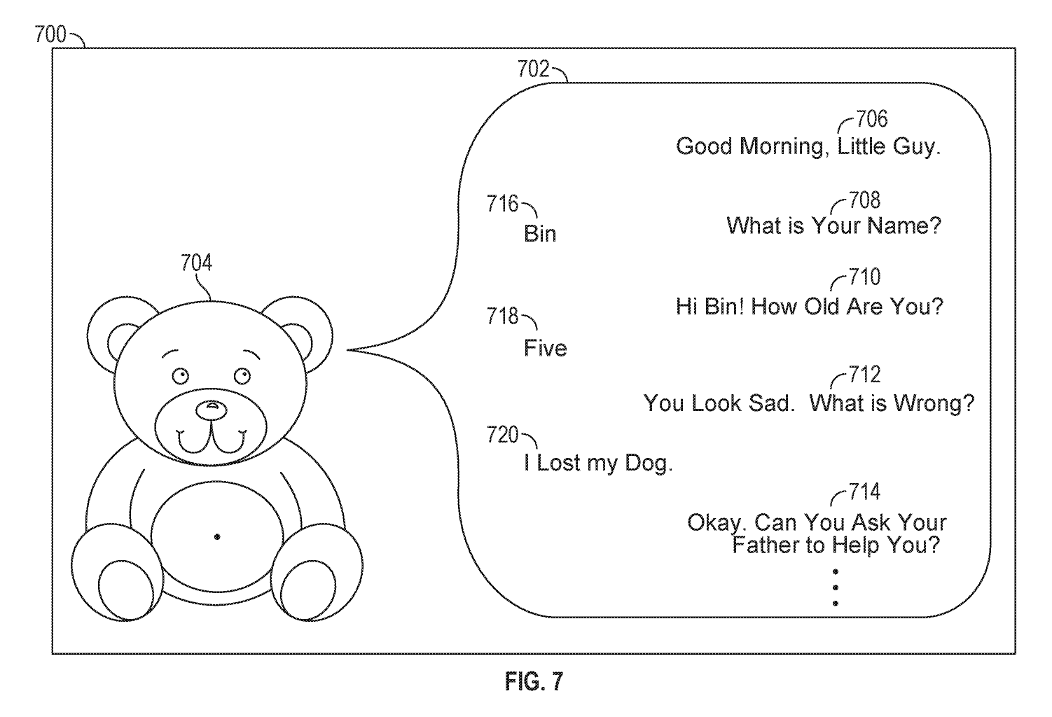

FIG. 7 is a diagram of a user interface 700 for a chat conversation 702 on a client computing device 100. The depicted chat conversation may be presented on a screen of a computing device 100 with a virtual avatar or assistant 704 (shown as a teddy bear) presenting text chat responses 706-714 to a child user who is responsively providing chat statements 716-720. Other examples may audibly present the chat conversation 702 through speakers of an electronic toy (e.g., a real teddy bear), through speakers of an automobile, or on presentation components of any other computing device.

Looking at the chat conversation 702, the assistant 702 proactively provides a greeting 706 and a probing question 708 to the child in order to begin the conversation. The child's response 716 to the question includes user profile data (a chat statement that indicate the child's name, “Bin”) that may be transmitted and stored with a new or existing user profile for the child. After the child provides his name, the assistant 702 responds with an excited statement 710, as indicated by the exclamation mark, and then asks another probing question to gather additional information to build the child's user profile. This back-and-forth probing may continue until the user profile of the child is built or until the child begins giving statements for particular tasks or with certain emotions. As shown, once the child provides his age in statement 718, the chat engine recognizes that the child is upset and asks the child what is wrong in response 712. Emotion detection and corresponding chat response selection may be performed by the previously discussed emotion-detection module 214, response selection module 218, and response learning module 222. After being asked why the child is sad, the child responds with the reason for his sadness, namely that he lost is dog.

A skills selector 224 of the chat engine server 202 recognizes that an expert may be able to help, and therefore generates and provides chat response 714 instructing the child contact his father for help. The chat conversation 702 may then continue and chat responses may be selected by the chat engine by the different selector components 224-240 discussed herein and chosen for presentation to the child based on the selected responses' ability to transition or align with the child's emotional state—e.g., as determined by the response learning module 222 rankings of responses.

### Additional Examples

Some examples are directed to systems, methods, and computer-readable media for providing emotionally intelligent chat conversations. Chat engine servers configured with memory with instructions for detecting emotions in user data received from a client computing device presenting a chat conversation, and one more configured to execute the instructions to: detect a chat statement in the user data, determine an emotional state of the user from user data, execute a sequence of response selector components to determine one or more responses to the chat statement, identify an emotionally tailored chat response to provide the user based on the emotional state of the user and the one or more responses, and transmit the emotionally tailored chat response to the client computing device for presentation to the user.

Some examples are directed to operating a chat engine and providing emotionally tailored chat responses to a user through performing several executable operations. User data is received from a user interacting with the chat engine; the user data comprising a chat statement from the user. An emotional state of the user based on the user data is identified. A chat statement of the user based on the user data is identified. A sequence of response selector components is executed to determine an emotionally tailored chat response to the chat statement based on the emotional state of the user, and emotionally tailored chat response is transmitted to the client computing device for presentation to the user.

Some examples are directed to providing emotionally tailored chat conversations to a user on a client computing devices through the following operations. User data is received that includes a chat statement of a user. An emotional state of the user is identified based on the chat statement. A sequence of response selector components is executed to determine one or more potential chat responses to the chat statement. Likelihoods that the potential chat responses can transition or maintain the emotional state of the user are calculated. An emotionally tailored chat response is selected based on the calculated likelihoods. The selected emotionally tailored chat response is transmitted to the client computing device for presentation to the user.

Alternatively or in addition to the other examples described herein, examples include any combination of the following:
execution of a skills selector configured to determine a response to the chat statement requires a predefined skill;
execution of an FAQ selector configured to determine the chat statement is asking a specific question related to a chat engine providing the chat conversation and generate a response that includes specific information about the chat engine;
execution of a knowledge base selector configured to access a knowledge-based index of information related to target users and generate a response that includes information from the knowledge-based index;
execution of an expert selector component configured to generate a response that recommends a designation of an expert;
execution of a proactive probe configured to generate a probing response for engaging with the user to gather additional chat statements;
execution of a domain-specific selector configured to generate a response based on a pattern of behavior for the user;
execution of a sanitized web selector configured to generate a sanitized response based on web domain-specific data or question-and-answer pairs;
execution of an RNN answer selector configured to generate a response using an RNN procedure;
response selector components that sequentially executes: a skills selector configured to determine a response to the chat statement requires a predefined skill, then an FAQ selector configured to determine the chat statement is asking a specific question related to a chat engine providing the chat conversation and generate a response that includes specific information about the chat engine, then a response selector components comprise a knowledge base selector configured to access a knowledge-based index of information related to target users and generate a response that includes information from the knowledge-based index, and then an expert selector component configured to generate a response that recommends a designation of an expert;
executable instructions to determine one or more rewards for the one or more responses based on the emotional state of the user, and select the emotionally tailored chat response based on the rewards;
executable instructions to calculate rankings based on likelihoods that the one or more responses can create an emotional transition in the user or maintain the emotional state of the user; and
generating a first possible chat response based on a predefined skill, generating a second possible chat response that is specific to the chat engine, generating a third possible chat response that includes information gathered from a web source, generating a fourth possible chat response that indicates an expert to contact, generating a fifth possible chat response that includes a probing question, generating a sixth possible chat response based on a pattern of behavior for the user, generating a seventh possible chat response comprising a sanitized version of domain-specific web data, and generating an eight possible chat response comprising a universal answer for responding to the chat statement of the user.

While the aspects of the disclosure have been described in terms of various examples with their associated operations, a person skilled in the art would appreciate that a combination of operations from any number of different examples is also within scope of the aspects of the disclosure.

### Exemplary Operating Environment

Although described in connection with an exemplary computing device, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

Exemplary computer readable media include flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer readable instructions, data structures, program modules, or other data in a modulated data signal such as a carrier wave or other transport mechanism and include any information delivery media.

The examples illustrated and described herein, as well as examples not specifically described herein but within the scope of aspects of the disclosure, constitute exemplary means for presenting an emotionally intelligent chat engine to a user. For example, the elements described in FIGS. 2 and 3, such as when encoded to perform the operations illustrated in FIGS. 4 and 5, constitute exemplary means for detecting chat statements in user data and determining the emotional state of the user based on user data; executing a sequence of response selector components to determine an emotionally tailored chat response to the chat statement based on the emotional state of the user; and/or calculating likelihoods that the potential chat responses can transition or maintain the emotional state of the user.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

1. A system including one or more chat engine servers, comprising:
memory storing executable instructions for detecting emotions in user data received from a client computing device presenting a chat conversation; and
one or more processors configured to execute the instructions to:
detect a chat statement in the user data,
determine an emotional state of the user from user data,
execute a sequence of response selector components to determine one or more responses to the chat statement,
identify an emotionally tailored chat response to provide the user based on the emotional state of the user and the one or more responses, and
transmit the emotionally tailored chat response to the client computing device for presentation to the user.

2. The system of claim 1, wherein the response selector components comprise a skills selector configured to determine a response to the chat statement requires a predefined skill.

3. The system of any of claims 1-2, wherein the response selector components comprise a frequently asked question (“FAQ”) selector configured to determine the chat statement is asking a specific question related to a chat engine providing the chat conversation and generate a response that includes specific information about the chat engine.

4. The system of any of claims 1-3, wherein the response selector components comprise a knowledge base selector configured to access a knowledge-based index of information related to target users and generate a response that includes information from the knowledge-based index.

5. The system of any of claims 1-4, wherein the response selector components comprise an expert selector component configured to generate a response that recommends a designation of an expert.

6. The system of any of claims 1-5, wherein the response selector components comprise a proactive probe configured to generate a probing response for engaging with the user to gather additional chat statements.

7. The system of any of claims 1-6, wherein the response selector components comprise a domain-specific selector configured to generate a response based on a pattern of behavior for the user.

8. The system of any of claims 1-7, wherein the response selector components comprise a universal answer selector configured to generate a universal response to the chat statement.

9. The system of any of claims 1-8, wherein client computing device comprises at least one member of a group comprising a mobile phone, a mobile tablet, an electronic toy, and an automobile.

10. The system of any of claims 1-9, wherein the response selector components sequentially execute a skills selector configured to determine a response to the chat statement requires a predefined skill, then a frequently asked question (“FAQ”) selector configured to determine the chat statement is asking a specific question related to a chat engine providing the chat conversation and generate a response that includes specific information about the chat engine, then a response selector components comprise a knowledge base selector configured to access a knowledge-based index of information related to target users and generate a response that includes information from the knowledge-based index, and then an expert selector component configured to generate a response that recommends a designation of an expert.

11. A method for operating a chat engine and providing emotionally tailored chat responses to a user, comprising:
receiving user data from a user interacting with the chat engine, the user data comprising a chat statement from the user;
identifying an emotional state of the user based on the user data;
identifying a chat statement of the user based on the user data;
executing a sequence of response selector components to determine an emotionally tailored chat response to the chat statement based on the emotional state of the user; and
transmitting the emotionally tailored chat response to the client computing device for presentation to the user.

12. The method of claim 11, further comprising at least one member of a group comprising:
generating a first possible chat response based on a predefined skill;
generating a second possible chat response that is specific to the chat engine;
generating a third possible chat response that includes information gathered from a web source;
generating a fourth possible chat response that indicates an expert to contact;
generating a fifth possible chat response that includes a probing question;
generating a sixth possible chat response based on a pattern of behavior for the user;
generating a seventh possible chat response comprising a sanitized version of domain-specific web data; and
generating an eight possible chat response comprising a universal answer for responding to the chat statement of the user.

13. One or more computer-storage memory embodied with machine-executable instructions for performing a method of providing emotionally tailored chat conversations to a user on a client computing devices, the instructions comprising:
receiving user data comprising a chat statement of a user;
identifying an emotional state of the user based on the chat statement;
executing a sequence of response selector components to determine one or more potential chat responses to the chat statement;
calculating likelihood values that the potential chat responses can transition or maintain the emotional state of the user;
selecting an emotionally tailored chat response based on the calculated likelihood values; and
transmitting the emotionally tailored chat response to the client computing device for presentation to the user.

14. The memory of claim 13, further comprising at least one member of a group comprising:
generating a first possible chat response based on a predefined skill;
generating a second possible chat response that is specific to the chat engine;
generating a third possible chat response that includes information gathered from a web source;
generating a fourth possible chat response that indicates an expert to contact;
generating a fifth possible chat response that includes a probing question;
generating a sixth possible chat response based on a pattern of behavior for the user;
generating a seventh possible chat response comprising a sanitized version of domain-specific web data; and
generating an eight possible chat response comprising a universal answer for responding to the chat statement of the user.

15. The memory of any of claims 13-14, further comprising generating the first possible chat response first, the second possible chat response second, and the third possible chat response third.
